(19) United States
(12) Patent Application Publication
(10) Pub. No.: US 2008/0271987 A1
(43) Pub. Date: Nov. 6, 2008

(54) SYSTEM AND METHOD FOR PREPARING NANOPARTICLES USING NON-THERMAL PULSED PLASMA

(75) Inventors: Chang Ho NOH, Suwon-si (KR); Tae Sung KIM, Suwon-si (KR); Kwang Su KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Gyeonggi-do (KR)

(21) Appl. No.: 11/951,467

(22) Filed: Dec. 6, 2007

(30) Foreign Application Priority Data
May 4, 2007 (KR) 10-2007-0043542

(51) Int. Cl. H05H 1/00

(52) U.S. Cl. 204/164; 422/186.04; 422/186.29

(57) ABSTRACT

A system for preparing nanoparticles using non-thermal pulsed plasma is provided. The system comprises a reaction chamber having two divided regions, i.e. a first region where nanoparticles are to be formed and a second region where the nanoparticles are to be received, to prevent the formation of a thin film of nanoparticles in the second region. The use of the system enables the preparation of nanoparticles with improved uniformity and high collection efficiency. In addition, collection and deposition of nanoparticles can be simultaneously performed in the second region. Therefore, the system can find applications in various fields, including devices, secondary cells and sensors. Further provided is a method for preparing nanoparticles using the system.

### PRIORITY STATEMENT

This application claims priority under U.S.C. § 119 to Korean Patent Application No. 10-2007-0043542, filed on May 4, 2007, in the Korean Intellectual Property Office (KIPO), the entire contents of which are incorporated herein by reference.

### BACKGROUND OF THE INVENTION

1. Field of the Invention

Example embodiments relate to a system and a method for preparing nanoparticles using non-thermal pulsed plasma. More specifically, example embodiments relate to a system for preparing nanoparticles using non-thermal pulsed plasma which comprises a reaction chamber having two divided regions, i.e. a region where nanoparticles are to be formed and a region where the nanoparticles are to be received, and a method for preparing nanoparticles using the system.

2. Description of the Related Art

Nanoparticles are ultrafine particles whose size is in the nanometer range (10⁻⁹ m) corresponding to the size of several hundred atoms or molecules. Such nanometer-sized particles have increased surface area and a capillary effect due to their decreased size. An increase in surface area has a great influence on chemical and catalytic reactions intimately associated with surface phenomena and the adsorption/desorption behaviors of different components. Capillary effect varies the basic physical properties of particles to induce the occurrence of new phenomena. Accordingly, nanoparticles find applications in various fields.

Methods for preparing particles are generally divided into gas-to-particle, liquid (aerosol)-to-particle and solid-to-particle conversion methods by the state of precursors used, and chemical and physical methods by the type of processing mechanisms employed. According to the solid-to-particle conversion methods, bulky materials are cut into smaller pieces by various techniques, e.g., pulverization, spray and milling. Generally, the solid-to-particle conversion methods are not suitable for the preparation of particles having a size smaller than 3 micrometers. According to the liquid-to-particle conversion methods, fluidization and atomization are employed to form liquid droplets or a chemical surface reaction is used to prepare particles. Examples of such liquid-to-particle conversion methods include sol-gel, hydrothermal and spray pyrolysis methods. The size of particles prepared by the liquid-to-particle conversion methods is determined by the size distribution of a precursor used. The liquid-to-particle conversion methods are suitable for the preparation of highly monodispersed particles. However, the liquid-to-particle conversion methods have many limitations in preparing particles. For example, the liquid-to-particle conversion methods cannot avoid the formation of chemical by-products. Further, the liquid-to-particle conversion methods present difficulties in the application to applied products and the collection and migration of particles. These limitations make the liquid-to-particle conversion methods unsuitable for practical application. In contrast, the gas-to-particle conversion methods employ a chemical reaction of a precursor gas. Accordingly, particles can be prepared in a build-up manner, which allows the particles to have various sizes.

On the other hand, as the methods based on a chemical mechanism, flash pyrolysis and laser pyrolysis are exemplified. The chemical methods require a large quantity of energy with respect to the amount of particles to be prepared because the particles are prepared at high temperatures. According to the methods based on a physical mechanism, gas-phase molecules and atoms are bombarded to prepare particles. Examples of such physical methods include gas condensation and laser ablation.

In recent years, methods and systems using plasma have been proposed and employed for the preparation of nanoparticles. Such plasma methods belong to gas-to-particle conversion methods. Gas-to-particle conversion methods have the advantages of small amounts of by-products, high purity, easy separation of particles from carrier gases and possibility of continuous processes when compared to liquid-to-particle conversion methods. Based on these advantages, gas-to-particle conversion methods are employed to prepare nanoparticles on an industrial scale.

Ease of process control, reproducibility and economic efficiency are considered as the most important factors in preparing nanoparticles. These factors enable the preparation of nanoparticles having a uniform size distribution in a stable manner and the collection of nanoparticles in an efficient manner.

According to conventional methods and systems for preparing nanoparticles using plasma, a thin film is inevitably formed in a region where nanoparticles are to be collected, making it impossible to prepare nanoparticles having a uniform distribution in a stable manner. Therefore, the conventional methods and systems have a problem in that the collection efficiency of nanoparticles is drastically lowered and a limitation in that nanoparticles cannot be additionally processed.

### SUMMARY OF THE INVENTION

Example embodiments have been made in an effort to solve the problems of the prior art, and example embodiments provide a system and a method for preparing nanoparticles that prevent the formation of a thin film of nanoparticles to achieve improved uniformity of nanoparticles and high collection efficiency.

Example embodiments provide a system and a method for preparing nanoparticles in which nanoparticles can be additionally processed.

Example embodiments provide a system for preparing nanoparticles using non-thermal pulsed plasma, the system comprising: a reaction chamber including a gas inlet port, a receiver and an grounded separator and having a region where nanoparticles are to be formed and a region where the nanoparticles are to be received, the two regions being divided by the separator; a gas supply part for transferring a process gas and an ambient gas to the reaction chamber via the gas inlet port; a power supply part for producing plasma within the reaction chamber; and a flow control part for creating a vacuum and controlling the flow of the gases.

Example embodiments provide a method for preparing nanoparticles using non-thermal pulsed plasma in the system, the method comprising the steps of creating a vacuum within the reaction chamber, introducing a process gas and an ambient gas into the reaction chamber in a vacuum state, controlling and fixing the internal pressure of the reaction chamber so as to maintain a steady-state flow of the gases, and applying plasma to a region where nanoparticles are to be formed to prepare nanoparticles and stopping the application of the plasma to receive the nanoparticles.

### BRIEF DESCRIPTION OF THE DRAWINGS

FIG. 1 is a schematic diagram illustrating a system for preparing nanoparticles according to example embodiments.

FIG. 2 is an enlarged schematic diagram illustrating a reaction chamber of the system of FIG. 1.

FIG. 3 is a flow chart of a method for preparing nanoparticles according to example embodiments.

FIG. 4 is a diagram schematically showing a waveform of pulsed plasma applied to a system of example embodiments.

FIG. 5 is a graph showing a variation in the size of particles prepared in the example embodiments as a function of pulse ON-time.

FIGS. 6a and 6b are photographs of particles prepared in the example embodiments before and after annealing, respectively, indicating that the crystal structure of the particles was changed from amorphous (FIG. 6a) to crystalline (FIG. 6b) by annealing.

FIG. 7a is a TEM X-ray diffraction pattern of the crystalline particles of FIG. 6b, and FIG. 7b is a graph showing the results of X-ray diffraction analysis for the crystalline particles of FIG. 6b.

### DESCRIPTION OF THE PREFERRED EMBODIMENTS

Example embodiments will now be described in greater detail with reference to the accompanying drawings.

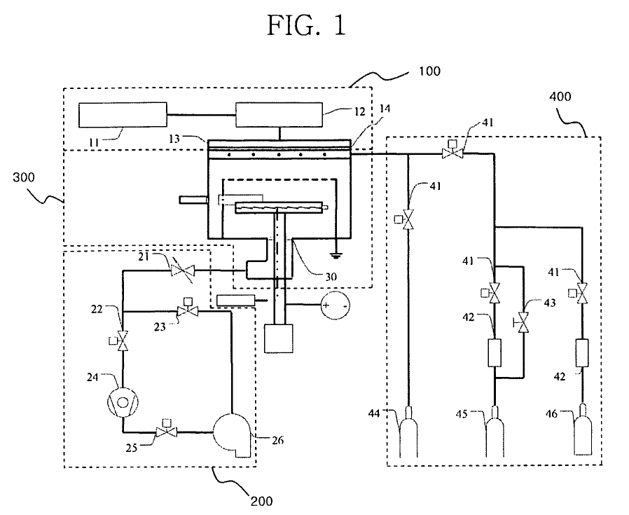

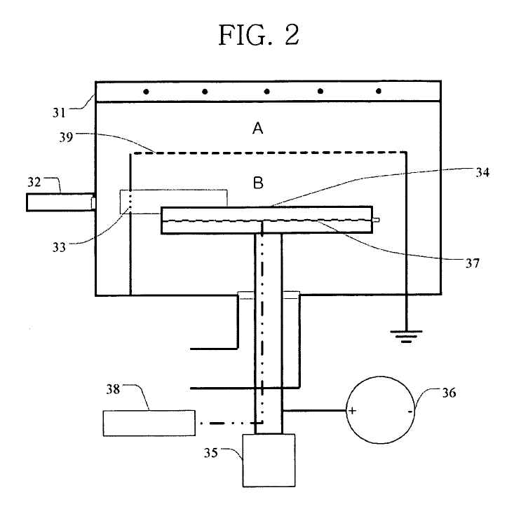

FIG. 1 is a schematic diagram illustrating a system for preparing nanoparticles according to example embodiments, and FIG. 2 is an enlarged schematic diagram illustrating a reaction chamber of the system of FIG. 1.

Example embodiments provide a system for preparing nanoparticles using non-thermal pulsed plasma. The system of example embodiments comprises: a reaction chamber including a gas inlet port, a receiver and an grounded separator and having a region where nanoparticles are to be formed and a region where the nanoparticles are to be received, the two regions being divided by the separator; a gas supply part for transferring a process gas and an ambient gas to the reaction chamber via the gas inlet port; a power supply part for producing plasma within the reaction chamber; and a flow control part for creating a vacuum and controlling the flow of the gases.

The system of example embodiments essentially comprises a reaction chamber 300, a gas supply part 400, a power supply part 100 and a flow control part 200.

The reaction chamber 300 includes a gas inlet port 31 through which gases are introduced thereinto, a receiver for receiving nanoparticles to be prepared, and an grounded separator 39 dividing a region A (hereinafter, also referred to simply as region A′) where nanoparticles are to be formed and a region B (hereinafter, also referred to simply as ‘region B’) where the nanoparticles are to be received.

The region A of the reaction chamber may be formed between the gas inlet port 31 and the separator 39.

The separator 39 may be composed of a perforated metal material through which nanoparticles are allowed to migrate from the region A to the region B.

The separator 39 is preferably an grounded metallic grid, but is not necessarily limited thereto.

There is no particular limitation on the material for the grid so long as the material is metallic. It is preferable that the grid be made of the same metal as the reaction chamber 300.

The separator 39 serves to separate the region A from the region B. The separation method is not specially limited. It is preferable that the separator 39 surround the receiver or be disposed in parallel to and between the gas inlet port 31 and the receiver to separate the region A from the region B.

The separator 39 may be a grid having tetragonal or circular meshes. The separator may consist of two or more layers.

The separator 39 may be made of a material selected from the group consisting of perforated membranes through which nanoparticles are allowed to migrate from the region A to the region B.

The receiver is disposed within the region B and is selected from the group consisting of a collector 34, a depositor and a combination thereof.

The collector 34 is an element on which nanoparticles can be mounted. The collector 34 may be selected from the group consisting of substrates, wafers and plates, but is not necessarily limited thereto.

In the embodiments shown in FIGS. 1 and 2, a substrate as the collector 34 is used as the receiver.

Nanoparticles can be collected or deposited in the region B. For example, in the region B, particles can be deposited and patterned on the surface of a wafer introduced into the chamber after completion of thin-film processing. Particularly, in the region B, particles can be deposited and patterned on a modified wafer surface using an electrical attractive force. This additional wafer processing can be directly applied to the fabrication of next-generation devices, including memory devices and sensors, using nanoparticles.

For better collection efficiency, the collector 34 may be provided with a DC bias power supply 36, a heater 37 for the preparation of crystalline particles and a heater controller 38.

The DC bias power supply 36 applies DC power to the collector to provide an electrical attractive force to negatively charged nanoparticles, thereby achieving increased collection efficiency of the collector.

To collect a sufficient amount of nanoparticles, the DC bias power supply is preferably operated in the voltage range of 0 to 10 KV. Since an RF pulse generator of the power supply part 100 is operated by AC, AC of plasma interacts with the DC bias to leave room for the occurrence of an arc. Accordingly, the most preferred voltage range of the DC bias is between 0 and 200 V.

The collector 34 may be provided with a height controller 35 to attain additional collection effects due to impaction arising from an inertial motion of particles having various sizes.

A view port 32 may be installed on a sidewall of the reaction chamber 300 to observe the state of plasma and install various measurement instruments. A transparent cover 33 may be provided on the separator 39 to observe the internal state of the region B.

The state of plasma during processing can be observed through the view port 32 and the transparent cover 33. The results of various measurement instruments (e.g., a Langmuir probe) may be checked through the view port 32.

The view port 32 may be connected to the transparent cover 33 to transfer particles to the outside of the chamber during processing. The particles escaping from the reaction chamber 300 can be measured for size distribution using a scanning mobility particle sizer (SMPS) or a particle beam mass spectrometer (PBMS) or can be transferred to another chamber where the particles can be further processed.

The collector 34 may be provided with a heater 37 to re-process amorphous nanoparticles to have a crystalline structure by annealing and a thermostat 38. The structure of particles prepared using the system of example embodiments is amorphous at the initial stage. The heater 37 serves to crystallize the amorphous particles. The particles may have any crystalline structure. The annealing temperature of the heater 37 may be controlled using the thermostat 38. The annealing time may be varied depending on the size of nanoparticles and the amount of heat emitted from the heater.

The gas supply part 400 may include a process gas 45, an ambient gas 46, a purge gas 44, lines through which the gases are transferred, and valves 41, 42 and 43 for regulating the flow rates of the gases.

The process gas 45 is a silane-based gas selected from the group consisting of SiH₄, SiCl₄, Si₂H₆, SiH₂Cl₂, SiF₄ and mixtures thereof. The process gas 45 is a gas that is capable of reacting with another gas within plasma and contains element(s) of particles to be prepared. The ambient gas can be selected from the group consisting of Ar, N₂, CO, and mixtures thereof, but is not necessarily limited thereto. The kind of the ambient gas may be suitably selected according to the constituent ingredients of particles to be prepared.

In the embodiments shown in FIGS. 1 and 2, Si and Ar are used as the process gas and the ambient gas, respectively.

The purge gas is a gas that purges the process gas and the ambient gas remaining within the reaction chamber 300 to adjust the internal pressure of the reaction chamber 300 to atmospheric pressure. Any known gas such as nitrogen or carbon dioxide may be used as the purge gas.

The power supply part 100 may include a plasma source 13 for the storage of plasma and an RF pulse generator 11 for applying the plasma in a pulsed mode.

The power supply part 100 may include a matching system 12 for delivering RF power generated from the RF pulse generator 11 to the plasma source 13.

In the embodiments shown in FIGS. 1 and 2, the power supply part 100 consists of the RF pulse generator 11, the plasma source 13, the matching system 12 and a ceramic plate 14.

The power supply part 100 applies a power of 0-600 W to the pulsed plasma at a frequency of 0-500 Hz to control the size of the nanoparticles. The power and frequency ranges may be appropriately varied depending on the kinds and flow rates of the gases, the size of the reaction chamber and the desired size of nanoparticles to be prepared.

The size of the nanoparticles may be controlled by varying the cycle and ON-time of the pulsed plasma. The cycle and ON-time may be appropriately varied depending on the kinds and flow rates of the gases, the size of the reaction chamber and the desired size of nanoparticles to be prepared.

The flow control part 200 may include a means for creating a vacuum within the reaction chamber, and a flow rate controller for controlling the flow of the gases and establishing a steady-state flow of the gases.

The vacuum-creating means may be a turbo molecular pump 24 or a combination of the turbo molecular pump 24 and a rotary pump 26, but is not necessarily limited thereto.

A throttle valve 21 may be installed in the flow rate controller to maintain a steady-state flow of the gases within the chamber. The throttle valve 21 can be synchronized with a pressure gauge provided within the chamber to automatically regulate the flow rates of the gases.

In the embodiments shown in FIGS. 1 and 2, the flow rate controller includes the throttle valve 21, a main angle valve 22, a roughing valve 23 and a foreline valve 25.

When the pressure of the reaction chamber is fixed to a constant level ranging from 1 mTorr to several hundred mTorr or ambient pressure using the flow rate controller to maintain a steady-state flow of the gases within the reaction chamber, variable influences on the preparation of particles are minimized, making it possible to prepare particles having a uniform size.

The flow rate controller may be a manual type, a computer-based system or a PLC type. To selectively control nanoparticles having a size of several nanometers and various size distributions and densities, it is preferred that the flow rate controller be a computer-based system or a PLC type rather than a manual type.

The reaction chamber 300 of the system according to example embodiments is divided into the region A where nanoparticles are to be formed and the region B where the nanoparticles are to be received. Accordingly, nanoparticles can be prepared and received in the divided regions A and B, respectively.

The separator 39 of the reaction chamber 300 is earthed. Plasma is produced only between the ceramic plate 14 and the separator 39 by the grounded separator.

Plasma applied to the region A of the reaction chamber by the power supply part 100 reacts with the process gas 45 and the ambient gas 46 transferred to the reaction chamber 300 by the gas supply part 400 to form nanoparticles. When the application of the plasma is stopped, the nanoparticles migrate to the region B by an inertial motion and an electric force.

Since no plasma is applied to the region B, the nanoparticles migrate to the region B along a stream of the nanoparticles. That is, the region B is called an ‘inertial region’. Accordingly, the nanoparticles continuously migrate to and are received on the surface of the collector. This continuous migration and receiving of the nanoparticles prevents the formation of a thin film of the nanoparticles.

Silane as the process gas 45 is decomposed into silicon and hydrogen atoms. Electrons generated from the hydrogen atoms and electrons generated from argon (Ar) as the ambient gas 46 react with the Si atoms to make the nanoparticles negatively charged. As a result, an electrical repulsive force is induced between the respective negatively charged nanoparticles to prevent aggregation of the particles and formation of a thin film of the particles.

Example embodiments also provide a method for preparing nanoparticles using the system. The method of example embodiments comprises the steps of creating a vacuum within the reaction chamber; introducing a process gas and an ambient gas into the reaction chamber in a vacuum state; controlling and fixing the internal pressure of the reaction chamber so as to maintain a steady-state flow of the gases; and applying plasma to the region A of the reaction chamber to prepare nanoparticles and stopping the application of the plasma to receive the nanoparticles.

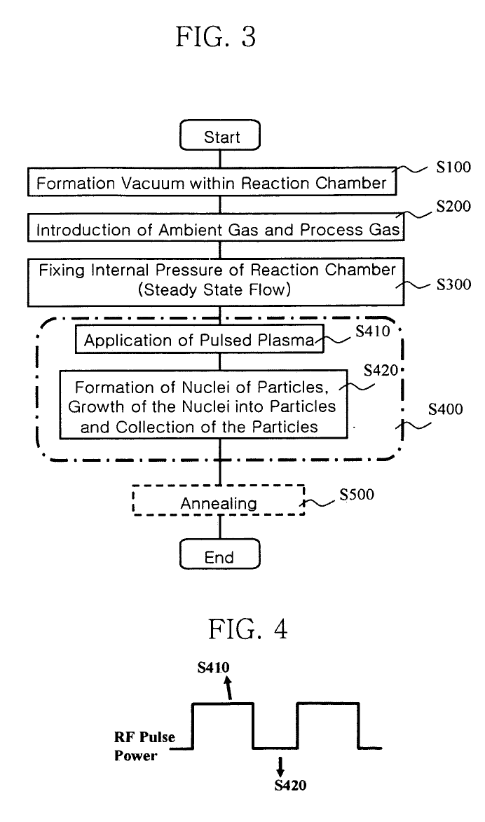

FIG. 3 is a flow chart of the method of example embodiments, and FIG. 4 is a diagram schematically showing a waveform of the applied pulsed plasma.

A more detailed explanation of the respective steps of the method according to example embodiments will be provided below.

Creation of Vacuum within Reaction Chamber (S100)

First, the vacuum-creating means is used to create a vacuum within the reaction chamber. The vacuum pressure of the reaction chamber is not particularly limited. For example, it is preferred to create a vacuum in the level of 1×10⁻⁶ mTorr to remove impurities and moisture contained in the reaction chamber affecting the formation of particles and reach a pressure at which plasma can be produced.

Supply of Process Gas and Ambient Gas (S200)

In this step, a process gas 45 and an ambient gas 46 are supplied to the reaction chamber 300 in a vacuum state using the gas supply part 400.

If the gases are compressed, the pressure of the gases may be directly used to supply the gases to the reaction chamber 300. If the gases are liquefied, a vaporizer may be additionally used to supply the gases to the reaction chamber 300.

Fixing of Internal Pressure of the Reaction Chamber (S300)

In this step, the internal pressure of the reaction chamber 300 is regulated such that a steady-state flow of the gases is maintained. After the gases are introduced into the reaction chamber in a vacuum state, the pressure of the gases within the chamber is preferably fixed using the flow rate controller. The size and density of particles are affected by a stream of the gases. The reason for the fixation of the internal pressure of the reaction chamber to maintain a steady-state flow of the gases is to minimize the influence on the preparation of particles.

Considering the characteristics of particles to be prepared, the internal pressure of the reaction chamber may be adjusted to a pressure ranging from 1 mTorr to several hundred mTorr or ambient pressure. It is desirable to determine the internal pressure of the reaction chamber taking into consideration the flow rates of the gases and the volume of the reaction chamber. Too low an internal pressure of the reaction chamber does not lead to the formation of particles. The amount of particles to be prepared is varied depending on the internal pressure of the reaction chamber and the flow rates of the process gas and ambient gas. Accordingly, the characteristics of particles to be prepared should be taken into consideration.

Preparation and Receiving of Nanoparticles (S400)

In this step, plasma is applied to the region A using the power supply part to prepare nanoparticles. When the application of the plasma is stopped, the nanoparticles migrate to and are received in the region B.

According to the method of example embodiments nanoparticles are prepared and received in the divided regions A and B, respectively. Accordingly, the preparation and receiving of nanoparticles can be separately conducted.

The plasma can be applied in a pulsed mode by the power supply part 100 to control the growth of nanoparticles.

The power supply part 100 can apply a power of 0-600 W to the pulsed plasma at a frequency 0-500 Hz to control the size of the nanoparticles. The power and frequency ranges may be appropriately varied depending on the kinds and flow rates of the gases, the size of the reaction chamber and the desired size of nanoparticles to be prepared.

The size of the nanoparticles may be controlled by varying the cycle and ON-time of the pulsed plasma. The cycle and ON-time may be appropriately varied depending on the kinds and flow rates of the gases, the size of the reaction chamber and the desired size of nanoparticles to be prepared.

FIG. 4 shows a waveform of the applied pulsed plasma. When the pulse is turned ‘ON’ (S410), the gases 45 and 46 introduced into the chamber react with the applied plasma to form nuclei of particles. The nuclei can be fixed in the region A by the plasma to grow into nanoparticles having a predetermined size. When the pulsed plasma is turned ‘OFF’ (i.e. no plasma is applied) (S420), the particles escape from the plasma due to an inertial force and can migrate to the region B.

The ON-time of the plasma controls the growth time of the particles and the OFF-time represents the time when the particles can migrate to the region B.

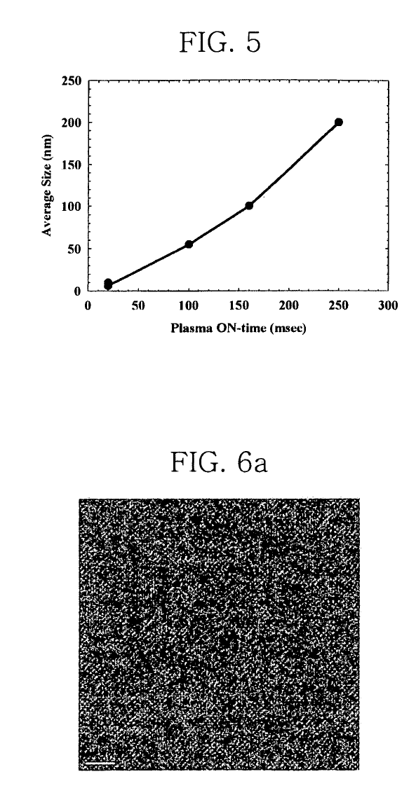

FIG. 5 shows a variation in the average size of the nanoparticles as a function of the ON-time of the plasma at a pulse cycle of 3 seconds or more.

In the step of receiving the nanoparticles, the nanoparticles may be collected on a collector 34 and/or deposited on a substrate, but are not necessarily limited thereto.

The collection of the nanoparticles may be achieved by applying DC bias power to the collector 34 to induce an electrical attractive force.

The height of the collector 34 may be regulated to increase the collection efficiency of the nanoparticles.

The nanoparticles may be annealed using a heater 37 installed inside the collector 34 to re-process the nanoparticles to have a crystalline structure.

Hereinafter, example embodiments will be explained in detail with reference to the accompanying drawings.

The system of example embodiments was comprised of a power supply part 100, a gas supply part 400, a flow control part 200, and a reaction chamber 300.

The power supply part was configured to include an RF pulse generator 11, a matching system 12 and a plasma source 13. A power generated from the RF generator 11 was controlled such that a variable power of 0-600 W was supplied to the plasma source 13. The frequency for the pulse may be varied. Taking into consideration the fact that the state of the plasma plays a critical role in the formation of particles, the pulse frequency was adjusted to the range of 0-50 Hz in the system of example embodiments.

The gas supply part 400 was configured to include silane (SiH₄) as a process gas 45, argon (Ar) as an ambient gas 46 and mass flow controllers (MFCs) 42. The process gas 45 and the ambient gas 46 were simultaneously supplied to a gas inlet port 31, and their flow rates were regulated by the MFCs 42.

The gas supply part was configured to include nitrogen (N₂) as a purge gas 44 supplied separately from the process gas 45 and the ambient gas 46 to recover the pressure of the reaction chamber to atmospheric pressure after processing. For the maintenance and management of the system, a screw-type valve 43 was installed to remove the toxic silane from the lines.

The reaction chamber 300 was configured to include a gas inlet port 31 through which the gases were introduced thereinto, a collector 34 for collecting nanoparticles, and a separator 39. An grounded grid was used as the separator 39. There is no particular limitation on the material for the grid. In the system of example embodiments the grid was made of the same material (i.e. stainless steel) as the reaction chamber 300.

In the example embodiments, the grid 39 was constructed in such a manner that it surrounded the collector 34. A substrate was used as the collector 34. The collector 34 was provided with a DC bias power supply 36, a heater 37, a heater controller 38 and a height controller.

For satisfactory collection of particles, a DC bias of 0 to 200 V was used in the DC bias power supply 36.

The reaction chamber 300 was provided with a view port 32 and a transparent cover 33 formed on the grid 39. A turbo molecular pump 24, a rotary pump 26 and a flow rate controller (23 and 21) were installed in the flow control part 200 to complete the fabrication of the system according to example embodiments.

Hereinafter, a method for preparing nanoparticles using the system will be explained.

First, a vacuum was created within the chamber 300. To this end, the rotary pump 26 operated and the valves 23 and 21 were sequentially opened to allow the internal pressure of the chamber to reach a pressure at which plasma could be produced. When the internal pressure of the chamber reached about a level of 1×10⁻² Torr, the valve 23 was closed, the turbo molecular pump 24 was operated and the valves 22 and 25 were opened to maintain the internal pressure of the chamber at a level of 1×10⁻⁶ mTorr.

Thereafter, the gas supply part 400 was used to supply gases to the reaction chamber. Silane (100%) 45 and argon 46 as the gases were simultaneously supplied to the reaction chamber. The flow rates of the gases were adjusted to 0.08 and 10 sccm using MFCs 42, respectively. After the gases began to supply, the throttle valve 21 connected to the pressure gauge installed within the chamber 300 was used to maintain the internal pressure of the chamber at around 300 mTorr.

After a height of the collector 34 was determined, a height-adjusting box 35 was used to adjust the height of the collector. It is more preferred to adjust the height of the collector before creation of a vacuum within the chamber.

After the flow of the gases within the chamber became a steady state, the pulse frequency was adjusted to 50 Hz depending on the size of particles to be prepared. A power of 200 W was applied to the pulsed plasma and the pulse cycle was adjusted to 3 seconds (ON-time of 20 ms and OFF-time of 2,980 ms). The plasma source 13 is a source for inductively coupled plasma (ICP). Depending on the size of particles to be collected, the electrical mobility of particles was calculated. The DC bias power supply 36 was used to apply a DC voltage (V_{DC}) of 0 to +200 V necessary for the calculated electrical mobility to the collector 34 to prepare nanoparticles. The nanoparticles were collected using the collector. Thereafter, the flow control part 200 was blocked and nitrogen gas 44 was introduced into the chamber 300 to adjust the internal pressure of the chamber 300 to atmospheric pressure, thus completing the preparation of the nanoparticles.

Annealing (S500)

In this step, the amorphous nanoparticles were crystallized. First, the plasma power 11 was turned ‘OFF’. The valve installed in the silane 45 supply line was closed to block the supply of the silane 45 only. The MFC 42 installed in the Ar supply line was used to regulate the amount of the Ar 46 necessary for annealing. The throttle valve 21 was used to maintain the internal pressure of the chamber 300 at 300 mTorr, which was the same as the vacuum pressure of the chamber 300 when the particles were prepared. Thereafter, the temperature of the heater 37 installed inside the collector 34 was controlled using the thermostat 38. For example, particles having a size of 5 nm or less were heated at 500° C. for 1.5 hours. After completion of the annealing, the flow control part 200 was blocked and nitrogen 44 was introduced to adjust the internal pressure of the chamber 300 to atmospheric pressure, thus completing the preparation of the nanoparticles.

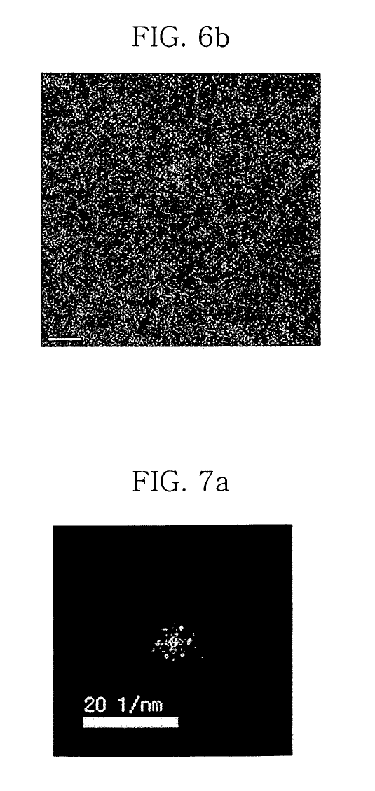

FIGS. 6a and 6b are photographs of the particles before and after annealing, respectively. The photographs reveal that the crystal structure of the particles was changed from amorphous to crystalline by annealing.

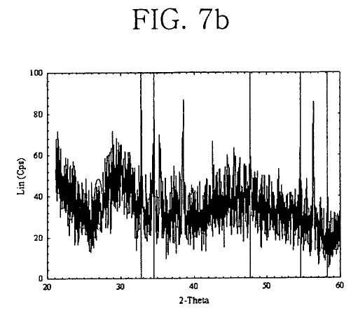

FIG. 7a is a TEM X-ray diffraction pattern of the crystalline particles of FIG. 6b, and FIG. 7b is a graph showing the results of X-ray diffraction analysis for the crystalline particles of FIG. 6b. FIGS. 7a and 7b show that the annealed particles are single crystalline and have a body-centered structure, which is a characteristic inherent to a crystalline structure. The shining portion shown in FIG. 7a represents crystal planes. The distances between the crystal planes are used to determine the structure of the particles. The graph of FIG. 7b is compared with the graphs of known materials to find the material most similar to the particles. FIGS. 7a and 7b show that the particles are the most close to Si and materials having a body-centered structure.

Although example embodiments have been disclosed for illustrative purposes, those skilled in the art will appreciate that various modifications and variations are possible, without departing from the technical spirit of the invention, and such modifications and variations are encompassed within the scope of the appended claims.

As apparent from the above description, example embodiments provide a system and a method for preparing nanoparticles using non-thermal pulsed plasma. The system of example embodiments comprises a reaction chamber having two divided regions, i.e. a first region where nanoparticles are to be formed and a second region where the nanoparticles are to be received. According to example embodiments, a thin film is not formed during collection of nanoparticles in the second region. Therefore, nanoparticles with improved uniformity can be prepared with high collection efficiency. In addition, according to example embodiments, collection and deposition of nanoparticles can be simultaneously performed in the second region. Therefore, the system and the method can find applications in various fields, including devices, secondary cells and sensors.

What is claimed is:

1. A system for preparing nanoparticles using non-thermal pulsed plasma, the system comprising:
a reaction chamber including a gas inlet port, a receiver and an grounded separator and having a first region where nanoparticles are to be formed and a second region where the nanoparticles are to be received, the first and second regions being divided by the separator;
a gas supply part for transferring a process gas and an ambient gas to the reaction chamber via the gas inlet port;
a power supply part for producing plasma within the reaction chamber; and
a flow control part for creating a vacuum and controlling the flow of the gases.

2. The system according to claim 1, wherein the first region is formed between the gas inlet port and the separator.

3. The system according to claim 1, wherein the receiver is disposed within the second region and is selected from the group consisting of a collector, a depositor and a combination thereof.

4. The system according to claim 1, wherein the separator is composed of a perforated metal material through which nanoparticles are allowed to migrate from the first region to the second region.

5. The system according to claim 1, wherein the separator is a grid.

6. The system according to claim 1, wherein the separator surrounds the receiver or is disposed in parallel to and between the gas inlet port and the receiver to separate the first region from the second region.

7. The system according to claim 3, wherein the collector is selected from the group consisting of substrates, wafers and plates capable of mounting nanoparticles thereon.

8. The system according to claim 3, wherein the collector is provided with a height controller.

9. The system according to claim 3, wherein the collector is provided with a heater to re-process amorphous nanoparticles to have a crystalline structure by annealing.

10. The system according to claim 3, further comprising a DC bias power supply that applies DC power to the collector to allow the collector to collect nanoparticles by an electrical attractive force.

11. The system according to claim 1, wherein the power supply part includes a plasma source for the storage of plasma and an RF pulse generator for applying the plasma in a pulsed mode.

12. The system according to claim 11, wherein power supply part includes a matching system for delivering RF power generated from the RF pulse generator to the plasma source.

13. The system according to claim 1, wherein the reaction chamber includes a view port installed on its sidewall and a transparent cover provided on the separator.

14. The system according to claim 1, wherein the flow control part includes a means for creating a vacuum within the reaction chamber, and a flow rate controller for fixing the pressure of the process gas and the ambient gas supplied after creation of the vacuum.

15. A method for preparing nanoparticles using non-thermal pulsed plasma in the system according to claim 1, the method comprising the steps of:
creating a vacuum within the reaction chamber;
introducing a process gas and an ambient gas into the reaction chamber in a vacuum state;
controlling and fixing the internal pressure of the reaction chamber so as to maintain a steady-state flow of the gases; and
applying plasma to the first region of the reaction chamber to prepare nanoparticles and stopping the application of the plasma to receive the nanoparticles.

16. The method according to claim 15, wherein the plasma is applied in a pulsed mode by the power supply part.

17. The method according to claim 15, wherein the power supply part applies a power of 0-600 W to the pulsed plasma at a frequency of 0-500 Hz to control the size of the nanoparticles.

18. The method according to claim 15, wherein the cycle and ON-time of the pulsed plasma are varied to control the size of the nanoparticles.

19. The method according to claim 15, wherein the nanoparticles are prepared by reacting the applied pulsed plasma with the gases to form nuclei of nanoparticles and fixing the nuclei in the region A to grow into nanoparticles.

20. The method according to claim 15, wherein the nanoparticles are received by stopping the application of the plasma to allow the nanoparticles to migrate to the second region by an inertial force.

21. The method according to claim 15, wherein the nanoparticles are received by collecting the nanoparticles on a collector and/or depositing the nanoparticles on a substrate.

22. The method according to claim 21, wherein the nanoparticles are collected by applying DC power to the collector to allow the collector to collect the nanoparticles by an electrical attractive force.

23. The method according to claim 21, wherein the height of the collector is regulated to increase the collection efficiency of the nanoparticles.

24. The method according to claim 21, wherein the nanoparticles are annealed using a heater installed inside the collector to re-process the nanoparticles to have a crystalline structure.

25. The method according to claim 15, wherein the pressure of the reaction chamber is fixed to 1 mTorr to ambient pressure after introduction of the process gas and the ambient gas into the reaction chamber in a vacuum state.
